(19) United States
(12) Patent Application Publication
(10) Pub. No.: US 2017/0117074 A1
(43) Pub. Date: Apr. 27, 2017

(54) Mn-X-BASED MAGNETIC MATERIAL

(71) Applicants: THE BOARD OF TRUSTEES OF THE UNIVERSITY OF ALABAMA, Tuscaloosa, AL (US); TDK CORPORATION, Tokyo (JP)

(72) Inventors: Takao Suzuki, Tuscaloosa, AL (US); Takahiro Suwa, Tokyo (JP)

(21) Appl. No.: 14/922,409

(22) Filed: Oct. 26, 2015

(51) Int. Cl. H01F 1/06; H01F 1/047

(52) U.S. Cl. CPC H01F 1/06; H01F 1/047

(57) ABSTRACT

Mn—X based magnetic materials (such as a binary Mn—X-based magnetic material, a ternary Mn—X-based magnetic material, a quaternary Mn—X-based magnetic material, or a quinary Mn—X-based magnetic material), wherein X denotes at least one element of Al, Bi, Ga, and Rh, are described herein. The Mn—X based magnetic materials can comprise particles having a particle size of 20 μm or less, wherein the particles comprise uniformly mixed constituent elements.

### STATEMENT OF GOVERNMENT SUPPORT

This invention was made with government support under Grant No. CMMI-1229049 awarded by the National Science Foundation. The government has certain rights in the invention.

### FIELD OF THE DISCLOSURE

The present disclosure relates generally to a magnetic material, such as a manganese (Mn) based magnetic material having improved saturation magnetization and coercive force.

### BACKGROUND

Magnetic materials are used in devices in a wide range of fields, such as magnetic recording media, tunneling magneto-resistive elements, magneto-resistive random access memories, and microelectromechanical systems (MEMS). In recent years, there has been a demand for finer and higher-performance microdevices and fine magnetic materials having improved magnetic properties.

The mechanism by which the magnetic properties of fine magnetic materials are exhibited can be different from that of bulk magnetic materials. Thus, fine magnetic materials can have different magnetic properties. One object in the development of magnetic materials for microdevices is therefore to produce thin films or fine particles having saturation magnetization and magnetic anisotropy similar to those of bulk magnetic materials.

Magnetic materials containing rare earth elements can have high magnetic anisotropy. Magnetic materials containing a neodymium compound (Nd₂Fe₁₄B) can be high-performance magnetic materials. (See Japanese Unexamined Patent Application Publication No. 2009-70857.)

However, rare earth elements are expensive and are potentially in limited supply. Thus, it is desirable to minimize the use of rare earth elements. Magnetic materials containing Mn compounds have been studied as magnetic materials having high magnetic anisotropy but without rare earth elements. (See International Publication WO 2015/065507.)

A structure for increasing the coercive force of a magnetic material has been proposed in the production of a fine magnetic material containing a Mn compound. In this structure, the magnetic material containing the Mn compound and having a diameter of approximately 50 nm is wrapped in a nonmagnetic material having a width of approximately 50 nm to divide the magnetic material. (See JOURNAL OF APPLIED PHYSICS 115, 17A737(2014).)

In such a structure, however, the volume percentage of the magnetic material containing the Mn compound decreases to approximately 60%, and accordingly the saturation magnetization and magnetic anisotropy of the structure are reduced as compared with the corresponding bulk magnetic material. What are thus needed are magnetic materials containing Mn with high saturation magnetization, coercive force, and/or magnetic anisotropy. The materials discussed herein address these and other needs.

### SUMMARY OF THE DISCLOSURE

Described herein are Mn—X-based magnetic materials. In some examples, the Mn—X-based magnetic materials can have a high magnetic anisotropy, coercive force, saturation magnetization, or any combination thereof. In some examples, the Mn—X-based magnetic materials can have a particle size of 20 μm or less.

The Mn—X-based magnetic materials described herein can, in some examples, be a binary, ternary, quaternary, or quinary Mn—X-based magnetic material. In some examples, X can comprise an element selected from the group consisting of Al, Bi, Ga, Rh, and combinations thereof. In some examples, the Mn—X-based magnetic materials can comprise particles having a particle size of 20 μm or less, wherein the particles can comprise uniformly mixed constituent elements.

In some examples, the uniformly mixed constituent elements can substantially narrow the nonmagnetic material region, increase the volume percentage of the magnetic material, or a combination thereof, which can thereby improve the saturation magnetization.

The term “uniformly mixed constituent elements”, as used herein, means that variations in the intensity ratio of the constituent elements at any positions in a material are within ±20% or less of the average intensity ratio as measured by energy dispersive X-ray spectroscopy (EDS) at a resolution of 5 nm or less.

The magnetic materials described herein are not limited to a single particle. In some examples, use of a plurality of particles of the magnetic materials described herein can enhance magnetization.

The magnetic materials described herein can, in some examples, comprise particles comprising MnBi in a low-temperature phase (LTP).

In certain examples, high magnetic anisotropy can be utilized in a wider temperature range.

The term “MnBi in a low-temperature phase”, as used herein, refers to Mn₅₀Bi₅₀, which forms a stable phase at 340° C. or less in its equilibrium state. It has been reported that the uniaxial magnetic anisotropy constant of bulk Mn₅₀Bi₅₀ is 1.5×10⁷ erg/cc or more at room temperature and increases with temperature up to 200° C.

In some examples, the magnetic materials can comprise particles that exhibit single domain magnetization behavior.

In certain examples, high magnetic anisotropy can be utilized in a particular direction.

In some examples, the magnetic materials can comprise particles having a thickness of 400 nm or more.

In certain examples, higher magnetization can be utilized.

In some examples, the magnetic materials can have a uniaxial magnetic anisotropy constant of 0.9×10⁷ erg/cc or more at a temperature in the range of 0° C. to 127° C., a coercive force of 13 kOe or more at a temperature in the range of 0° C. to 127° C., a saturation magnetization of 400 emu/cc or more at room temperature, or any combination thereof.

The Mn—X-based magnetic materials described herein can be free of rare earth elements and can have high saturation magnetization, magnetic anisotropy, and/or coercive force, even when the Mn—X-based magnetic material has a particle size of 20 μm or less.

### BRIEF DESCRIPTION OF THE DRAWINGS

FIG. 1 is a SEM image of a surface in Example 1.

FIG. 2 includes STEM images and EDS analysis results of a cross section in Example 1.

FIG. 3 is a hysteresis loop at a maximum applied magnetic field of 90 kOe in Example 1.

FIG. 4 is a graph of the relationship between coercive force and temperature in Examples 1, 2, and 3 and Comparative Example 2.

FIG. 5 is a graph of the relationship between saturation magnetization and temperature in Examples 1, 2, and 3 and Comparative Example 2.

FIG. 6 is a graph of the relationship between uniaxial magnetic anisotropy constant and temperature in Examples 1 and 2 and Comparative Example 2.

FIG. 7 is a SEM image of a surface in Example 2.

FIG. 8 includes STEM images and EDS analysis results of a cross section in Example 2.

FIG. 9 is a SEM image of a surface in Example 3.

FIG. 10 includes STEM images and EDS analysis results of a cross section in Example 3.

FIG. 11 is an optical microscope image of a surface in Example 4.

FIG. 12 is an optical microscope image of a surface in Comparative Example 1.

FIG. 13 includes STEM images and EDS analysis results of a cross section in Comparative Example 2.

### DETAILED DESCRIPTION

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

Described herein are magnetic materials. In some examples, the magnetic materials can be free of rare earth elements. An example of a magnetic material free of rare earth elements is a manganese (Mn) based material. Manganese is more abundant than rare earth elements and can be preferable to rare earth elements in terms of raw material costs and supply. Mn—Al, Mn—Bi, Mn—Ga, and Mn—Rh are known to be ferromagnetic at room temperature. In spite of containing no rare earth elements, Mn—Al, Mn—Bi, and Mn—Ga have high magnetic anisotropy. Mn-based materials are therefore promising materials for magnets. Examples of Mn—X-based magnetic materials described herein can include binary compounds, such as Mn—Al, Mn—Bi, Mn—Ga, and Mn—Rh, ternary compounds, such as Mn—Al—Bi, Mn—Al—Ga, Mn—Al—Rh, Mn—Bi—Ga, Mn—Bi—Rh, and Mn—Ga—Rh, quaternary compounds, such as Mn—Al—Bi—Ga, Mn—Al—Bi—Rh, Mn—Al—Ga—Rh, and Mn—Bi—Ga—Rh, and quinary compounds, such as Mn—Al—Bi—Ga—Rh. In some examples, the magnetic materials according can comprise elements other than the elements described above.

The magnetic materials can, in some examples, comprise particles having a particle size of 20 μm or less and/or can comprise uniformly mixed constituent elements. For example, the particle size can be 20 μm, 15 μm, 10 μm, 5 μm, or 1 μm, where any of the stated values can form an upper or lower end point of a range. In other examples the lower limit of the particles can be 1 μm. When the particle size in a face parallel to the substrate surface is 20 μm or less, the coercive force can be 13.1 kOe or more, and the saturation magnetization can be 460 emu/cc or more.

As used herein, the particle size is the average of the major length on a face of each particle parallel to the substrate face in a predetermined number of particles (e.g., 20 or more particles) observed with an optical microscope or scanning electron microscope (SEM). The major length is the length of a long side of a “rectangle having a minimum area” circumscribing each particle.

As used herein, the thickness of particles is the average of the maximum thickness of each particle in a direction perpendicular to the substrate face in a predetermined number of particles (e.g., 10 or more particles) as measured by step profiling with an atomic force microscope (AFM).

In some examples, the magnetic material can comprise particles comprising MnBi in a low-temperature phase; this can allow the magnetic material to have high magnetic anisotropy in a wider temperature range.

The magnetic materials can, for example, comprise particles that exhibit single domain magnetization behavior, which can allow the magnetic materials to have high magnetic anisotropy in a particular direction.

Particles that exhibit single domain magnetization behavior can be particles that have no magnetic domain wall and in which the magnetization process proceeds only by magnetization rotation. The presence of magnetic domain walls can be confirmed with a magnetic force microscope (MFM) or Lorentz electron microscope.

The magnetic materials can, for example, comprise particles having a thickness of 400 nm or more, for example, to enhance magnetization.

Since there is a demand for higher-performance magnetic materials, the magnetic materials described herein can, for example, have a uniaxial magnetic anisotropy constant of 0.9×10⁷ erg/cc or more at a temperature in the range of 0° C. to 127° C., a coercive force of 13 kOe or more at a temperature in the range of 0° C. to 127° C., a saturation magnetization of 400 emu/cc or more at room temperature, or any combination thereof.

### Method for Producing Magnetic Material

The magnetic materials described herein can, for example, be produced as described below. First, a target material is prepared as a raw material. For example, a Mn—X alloy target material having a desired composition can be used as the target material. The composition of the target material can be different from the composition of a film formed by sputtering because each element can have a different sputtering yield. The composition of the target material can, in some examples, be adjusted. In some examples, single-element targets of Mn and X can be used at an appropriate ratio for sputtering. In some examples, an alloy target and a single-element target can be used in combination at an appropriate ratio for sputtering. Oxygen can decrease the coercive force of magnetic materials. Therefore, in some example, the oxygen content of each target material can be minimized.

Target materials can be oxidized from their surfaces during storage. Thus, in some examples, the target materials can be sputtered to expose a clean surface before use.

A substrate on which a film is to be formed by sputtering can be made of any material, such as metal, glass, silicon, or ceramic. In some examples, the substrate can be fused silica. In other examples, the substrate can be MgO.

The pressure of a vacuum chamber in a film deposition system for sputtering can, for example, be 10⁻⁶ Torr or less (e.g., 10⁻⁸ Torr or less), for example, to minimize the amounts of impurity elements, such as oxygen. As discussed above, in some examples, the target materials can be sputtered to expose a clean surface before use. Thus, the film deposition system can, in some examples, have a shielding mechanism operable under vacuum between the substrate and the target material. The sputtering method can, for example, be a magnetron sputtering method. In some examples, in order to prevent the formation of impurities by a reaction between a magnetic material and an atmosphere gas, an inert element, such as argon, can be used as the atmosphere gas. The sputtering power source can be DC or RF, for example, depending on the type of target material.

The target material and the substrate can be used to form a film. Examples of the film-forming method can include a simultaneous sputtering method for forming a film using a plurality of targets at the same time, a sequential sputtering method for forming a film by sequentially using targets, and a single sputtering method for forming a film using a single alloy target having an adjusted composition.

A film of the magnetic material can have any thickness depending, for example, on the sputtering power, sputtering time, and/or argon atmosphere pressure. In some examples, in order to adjust the thickness, the film deposition rate can be measured in advance. The film deposition rate can be measured, for example, by a contact step-profiling method, X-ray reflectometry, and/or ellipsometry. In some examples, a quartz thickness monitor can be installed in the film deposition system to monitor film deposition rate and/or film thickness.

In some examples, the substrate temperature can be maintained at room temperature during sputtering. After the deposition, the film can be crystallized, for example, by annealing. During the annealing, Mn and Bi can be crystallized, and crystallized MnBi can be segregated and aggregated. In some examples, the film can then undergo heat treatment at a temperature in the range of 400° C. to 600° C. In some examples, the substrate can be heated to perform deposition and crystallization simultaneously during sputtering. The substrate can be heated under vacuum or in an inert gas atmosphere, for example, to minimize oxidation.

A Mn—X-based magnetic material thus produced can, in some examples, be covered with a protective film comprising, for example, Cr, Mo, Ru, and/or Ta. The protective film can, in some examples, substantially prevent the Mn—X magnetic material from being oxidized. The protective film, for example, can be formed after the Mn—X-based magnetic material is annealed and before the Mn—X-based magnetic material is exposed to the air. In some examples, the protective film can be formed before the annealing.

The examples and comparative examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

A Mn single-element target and a Bi single-element target were used as target materials. The substrate on which the film was to be formed was a MgO single-crystal substrate. The crystal orientation on the substrate surface was (110).

A film deposition system used to form the film on the substrate included a plurality of sputtering mechanisms and substrate heating mechanisms in one chamber. The pressure of the film deposition system could be decreased to 10⁻⁸ Torr or less. A target material as described above and a Ru target material for forming a protective film were placed in the film deposition system. Sputtering was performed in an argon atmosphere by a magnetron sputtering method using a DC power source.

The power of the DC power source and the argon atmosphere pressure were adjusted such that the Mn deposition rate was 0.01 nm/s and the Bi deposition rate was 0.06 nm/s. Films were formed by a sequential sputtering method in which 3.2 nm of Bi and 2.0 nm of Mn were alternately sputtered 10 times each.

A MnBi multilayer film thus formed was annealed at 450° C. in a vacuum to crystallize the MnBi. In the annealing, the temperature was increased for 30 minutes, was held for 30 minutes, and was decreased for 5 hours. After the MnBi multilayer film was cooled to room temperature, Ru was deposited as a protective film.

FIG. 1 shows a scanning electron microscope (SEM) image of a surface of a sample thus produced. MnBi particles in the visual field are almost entirely segregated into islands. The MnBi particles had a particle size of 10 μm. The term “segregated into islands”, as used herein, means that more than 90% of particles in a visual field are segregated in surface observations with a SEM or optical microscope.

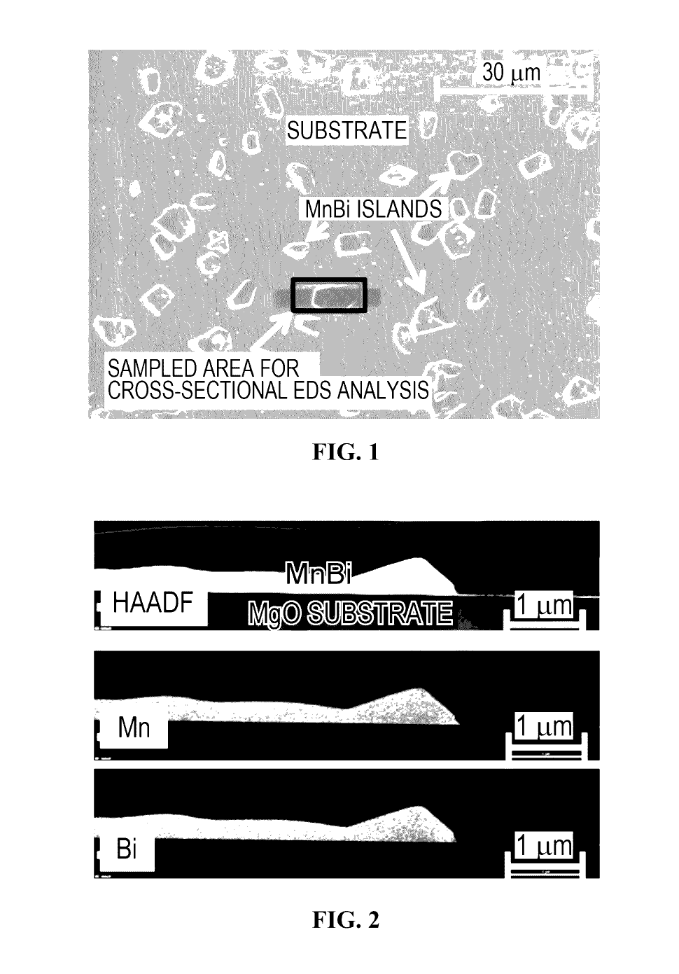

FIG. 2 shows a high-angle annular dark field (HAADF) image of the sample taken with a cross section scanning transmission electron microscope (STEM) and the distribution of Mn and Bi analyzed by energy-dispersive X-ray spectroscopy (EDS). FIG. 2 shows that the thickness of the MnBi particle was 500 nm or more. The EDS measurement results show that variations in the intensity ratio of Mn to Bi at different positions were ±20% or less of the average intensity ratio, indicating that Mn and Bi were uniformly mixed in each particle.

The crystal structure of the sample was then characterized by X-ray diffractometry. Excluding the peaks assigned to the substrate, only peaks assigned to crystal orientations (002) and (004) of MnBi in a low-temperature phase were observed, indicating that the sample was composed of MnBi in the low-temperature phase.

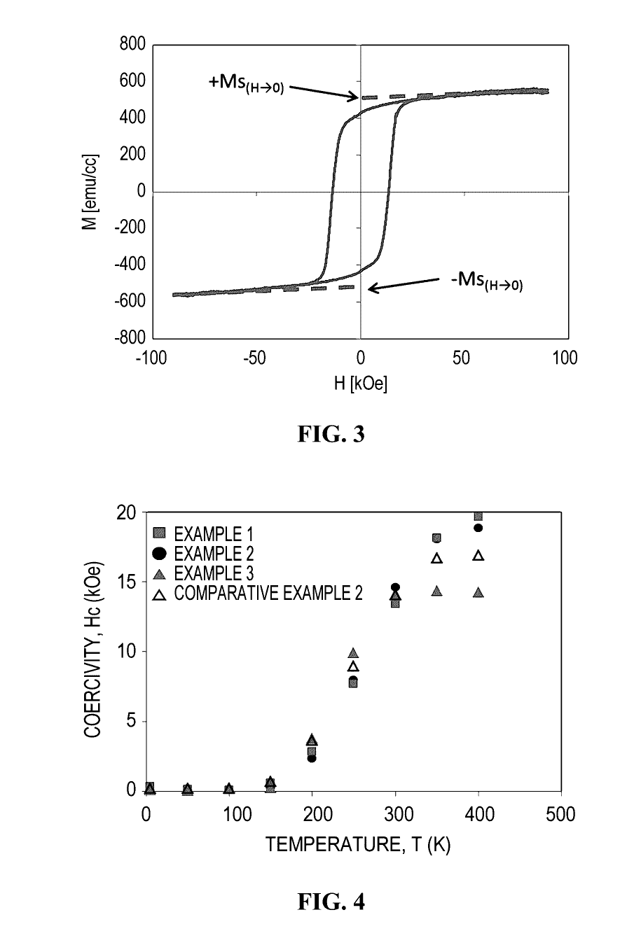

FIG. 3 displays a hysteresis loop of the sample measured in a direction perpendicular to the substrate face with a vibrating sample magnetometer (VSM) having a maximum applied magnetic field of 90 kOe. The coercive force was 13.4 kOe, and the saturation magnetization was 490 emu/cc. As used herein, “saturation magnetization” will be described below with reference to FIG. 3. The point of contact of the tangent line at +90 kOe with the Y-axis is referred to as +Ms_{(H→0)}. The point of contact of the tangent line at −90 kOe with the Y-axis is referred to as −Ms_{(H→0)}. The average of the absolute values of +Ms_{(H→0)} and −Ms_{(H→0)} is defined as saturation magnetization. The volume used for the estimation of saturation magnetization was the volume of particles in a film state before segregation into islands. More specifically, the volume was estimated by multiplying the surface area by the nominal thickness of the film.

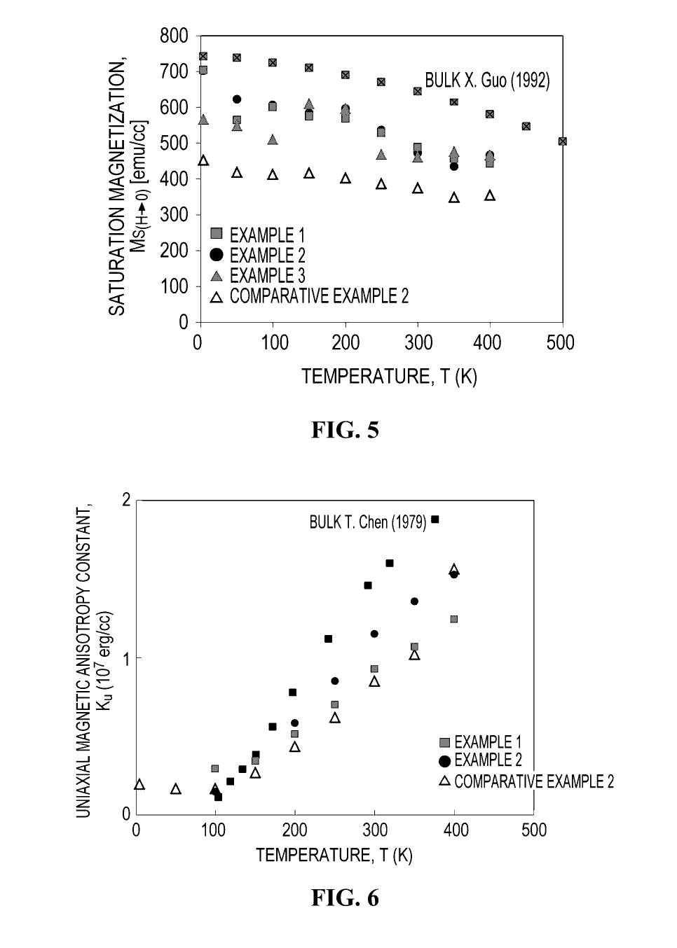

In the same manner, a hysteresis loop in a direction perpendicular to the substrate face was also measured with the vibrating sample magnetometer at a temperature in the range of 4 to 400 K, and the coercive force, saturation magnetization, and uniaxial magnetic anisotropy constant were estimated. FIG. 4 shows the relationship between coercive force and temperature. FIG. 5 shows the relationship between saturation magnetization and temperature. FIG. 6 shows the relationship between uniaxial magnetic anisotropy constant and temperature. FIGS. 5 and 6 also show the corresponding relationship reported for a bulk magnetic material. It was found that the magnetic material had a uniaxial magnetic anisotropy constant of 0.9×10⁷ erg/cc or more and a coercive force of 13 kOe or more at a temperature in the range of 0° C. to 127° C., and a saturation magnetization of 400 emu/cc or more at room temperature.

### Example 2

A sample comprising a film formed on a MgO single-crystal substrate was produced in the same manner as in Example 1, except that the crystal orientation on the substrate surface was (100).

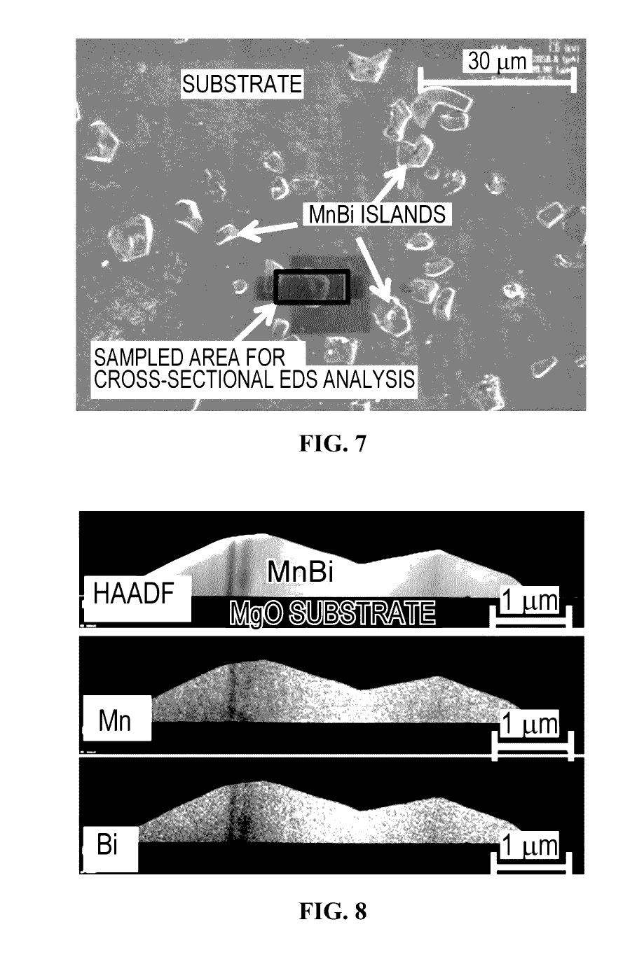

The sample was subjected to the measurements described in Example 1. FIG. 7 shows a surface observed with a SEM, and FIG. 8 shows the STEM and EDS measurement results for the sample. It was found that MnBi particles were segregated into islands. The particle size was 10 μm, and the thickness of the particles was 700 nm or more. The EDS measurement results show that variations in the intensity ratio of Mn to Bi at different positions were ±20% or less of the average intensity ratio, indicating that Mn and Bi were uniformly mixed in each particle. The crystal structure of the sample was characterized by X-ray diffractometry. The sample was composed of MnBi in a low-temperature phase. Table 1 lists coercive force and saturation magnetization in a direction perpendicular to the substrate face for the sample. The results for Example 1 (described above) and Examples 3-4 and Comparative Examples 1 and 2 (described below) are also listed in Table 1. FIG. 4 shows the relationship between coercive force and temperature at a temperature in the range of 4 to 400 K. FIG. 5 shows the relationship between saturation magnetization and temperature. FIG. 6 shows the relationship between uniaxial magnetic anisotropy constant and temperature. It was found that the magnetic material had a uniaxial magnetic anisotropy constant of 0.9×10⁷ erg/cc or more and a coercive force of 13 kOe or more at a temperature in the range of 0° C. to 127° C., and a saturation magnetization of 400 emu/cc or more at room temperature.

TABLE 1
Summary of sample properties for Examples 1-4 and Comparative Examples 1 and 2.

| | | Annealing | Particle | | Coercive | Saturation |
|---|---|---|---|---|---|---|
| | | temperature | size | Thickness | force | magnetization |
| | Substrate material | (° C.) | (μm) | (nm) | (kOe) | (emu/cc) |
| Example 1 | MgO single | 450 | 10 | 500 | 13.4 | 490 |
| | crystal (110) | | | | | |
| Example 2 | MgO single | 450 | 10 | 700 | 14.6 | 470 |
| | crystal (100) | | | | | |
| Example 3 | Fused silica glass | 450 | 10 | 400 | 14.1 | 460 |
| Example 4 | Fused silica glass | 420 | 20 | — | 13.1 | 460 |
| Comparative | Fused silica glass | 370 | 50 | — | 1.5 | 20 |
| example 1 | | | | | | |
| Comparative | Fused silica glass | 550 | 4500 | 52 | 14.1 | 380 |
| example 2 | | | | | | |

### Example 3

A sample was produced in the same manner as in Example 1, except that substrate on which a film was to be formed was a fused silica glass substrate.

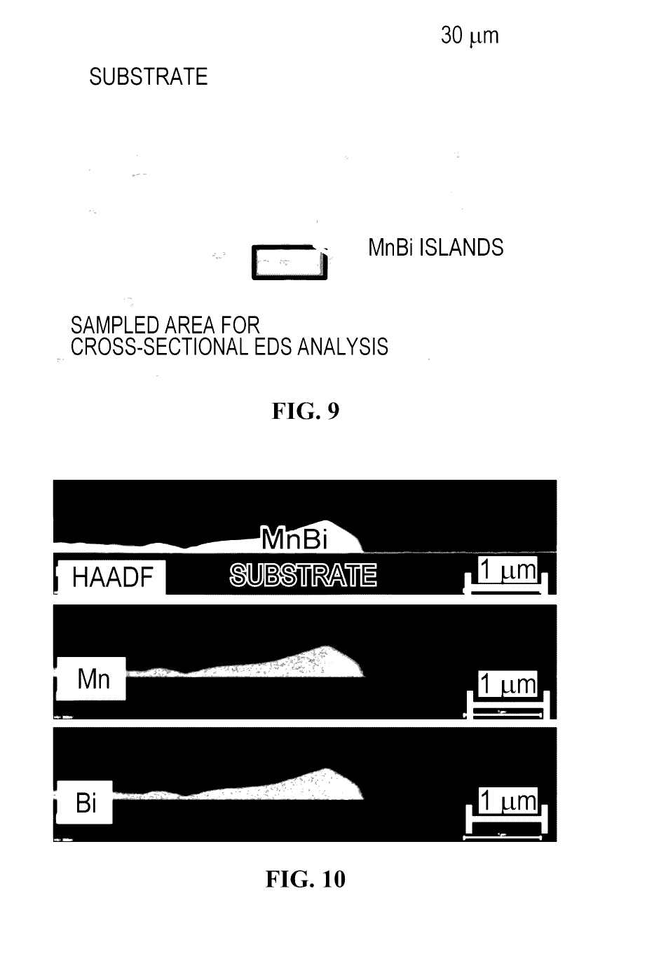

The sample was subjected to the measurements described in Example 1. FIG. 9 shows a surface observed with a SEM, and FIG. 10 shows STEM and EDS measurement results. It was found that MnBi particles were segregated into islands. The particle size was 10 μm, and the thickness of the particles was 400 nm or more. The EDS measurement results show that variations in the intensity ratio of Mn to Bi at different positions were ±20% or less of the average intensity ratio, indicating that Mn and Bi were uniformly mixed in each particle. The crystal structure of the sample was characterized by X-ray diffractometry. The sample was composed of MnBi in a low-temperature phase. Table 1 lists coercive force and saturation magnetization in a direction perpendicular to the substrate face. FIG. 4 shows the relationship between coercive force and temperature at a temperature in the range of 4 to 400 K. FIG. 5 shows the relationship between saturation magnetization and temperature. It was found that the magnetic material had a coercive force of 13 kOe or more at a temperature in the range of 0° C. to 127° C. and a saturation magnetization of 400 emu/cc or more at room temperature.

### Example 4

A sample was produced in the same manner as in Example 3, except that the annealing temperature was 420° C.

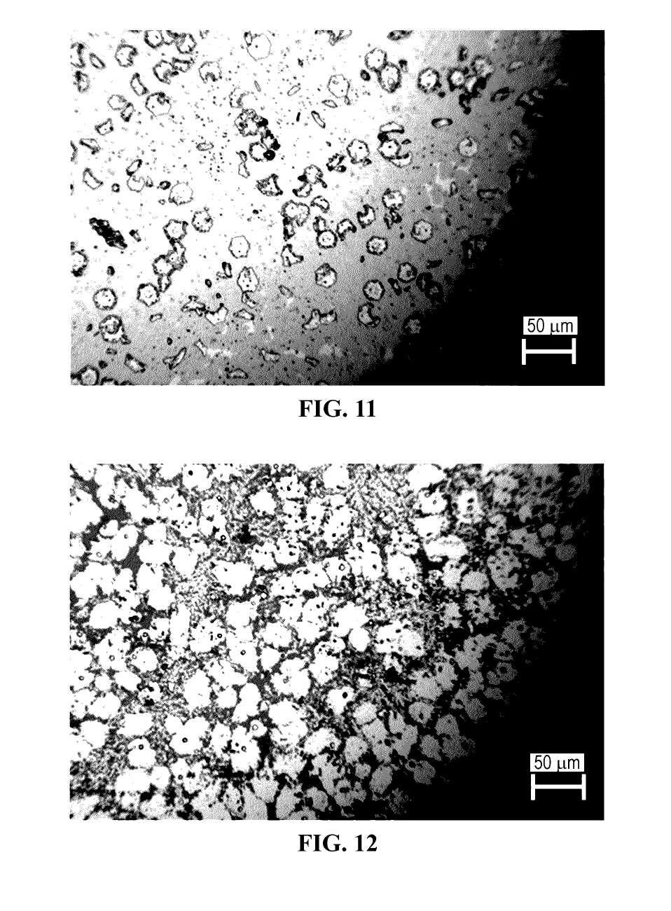

FIG. 11 shows a surface of the sample observed with an optical microscope. It was found that MnBi particles were segregated into islands. The particle size was 20 μm. The crystal structure of the sample was characterized by X-ray diffractometry. The sample was composed of MnBi in a low-temperature phase. The coercive force and saturation magnetization in a direction perpendicular to the substrate face were then measured with the vibrating sample magnetometer in the same manner as in Example 1. The measurement results are also listed in Table 1.

### Comparative Example 1

A sample was produced in the same manner as in Example 3, except that the annealing temperature was 370° C.

FIG. 12 shows a surface of the sample observed with an optical microscope. MnBi particles were insufficiently segregated, and particles having a size in the range of 30 to 50 μm were joined together. The particle size was 50 μm. The coercive force and saturation magnetization in a direction perpendicular to the substrate face were then measured with the vibrating sample magnetometer in the same manner as in Example 1. The measurement results are also listed in Table 1.

### Comparative Example 2

A sample was produced in the same manner as in Example 3, except that the annealing temperature was 550° C., the Mn deposition rate was 0.02 nm/s, and the Bi deposition rate was 0.07 nm/s.

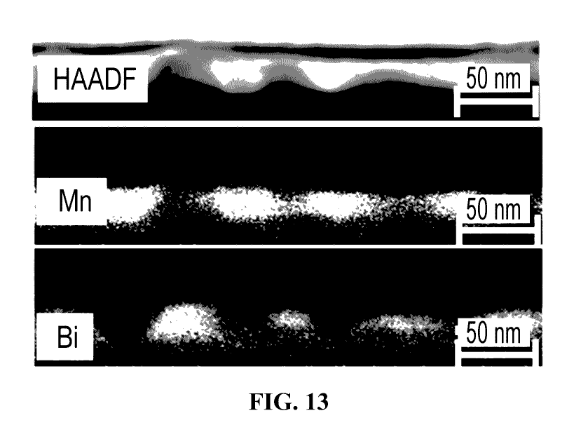

FIG. 13 shows cross sections of the sample observed by STEM and EDS. MnBi were not segregated and formed a film having a uniform thickness. Because all the MnBi particles were joined together, the particle size was the same as the film area and was 4.5 mm. The EDS measurement results show that variations in the intensity ratio of Mn to Bi at different positions were more than ±20% of the average intensity ratio, indicating that Mn and Bi were not uniformly mixed in the film. The crystal structure of the sample was characterized by X-ray diffractometry. The sample was composed of MnBi in a low-temperature phase and Bi. The sample was then subjected to measurements with the vibrating sample magnetometer in the same manner as in Example 1. The coercive force and saturation magnetization in a direction perpendicular to the substrate face were measured. The measurement results are also listed in Table 1. FIG. 4 shows the relationship between coercive force and temperature at a temperature in the range of 4 to 400 K. FIG. 5 shows the relationship between saturation magnetization and temperature. FIG. 6 shows the relationship between uniaxial magnetic anisotropy constant and temperature. The saturation magnetization at room temperature was 400 emu/cc or less, and the uniaxial magnetic anisotropy constant was 0.9×10⁷ erg/cc or less. These saturation magnetization and uniaxial magnetic anisotropy constant were much lower than those of a bulk magnetic material. This is probably because the volume percentage of MnBi was decreased.

These results show that MnBi composed of particles having a particle size of 20 μm or less and containing uniformly mixed constituent elements had a uniaxial magnetic anisotropy constant of 0.9×10⁷ erg/cc or more and a coercive force of 13 kOe or more at a temperature in the range of 0° C. to 127° C., and a saturation magnetization of 400 emu/cc or more at room temperature, and had high magnetic anisotropy, coercive force, and saturation magnetization.

As described above, Mn-based magnetic materials that are free of rare earth elements and having high magnetic anisotropy, coercive force, and saturation magnetization were formed. Such a magnetic material can contribute to the development of finer and higher-performance microdevices, such as MEMS.

What is claimed is:

1. A magnetic material comprising: a binary, ternary, quaternary, or quinary Mn—X-based magnetic material, wherein X comprises at least one element of Al, Bi, Ga, and Rh, and wherein the magnetic material comprises particles having a particle size of 20 μm or less, wherein the particles contain uniformly mixed constituent elements.

2. The magnetic material according to claim 1, wherein the particles comprise MnBi in a low-temperature phase.

3. The magnetic material according to claim 1, wherein the particles exhibit single domain magnetization behavior.

4. The magnetic material according to claim 1, wherein the particles have a thickness of 400 nm or more.

5. The magnetic material according to claim 1, wherein the magnetic material has a uniaxial magnetic anisotropy constant of 0.9×10⁷ erg/cc or more at a temperature in the range of 0° C. to 127° C., a coercive force of 13 kOe or more at a temperature in the range of 0° C. to 127° C., a saturation magnetization of 400 emu/cc or more at room temperature, or a combination thereof.
